(19) United States
(12) Patent Application Publication
(10) Pub. No.: US 2011/0192952 A1
(43) Pub. Date: Aug. 11, 2011

(54) Angle Adjustment Device for a Vehicle Rear View Mirror

(76) Inventor: Chin-Hui CHIANG, Taichung County (TW)

(21) Appl. No.: 12/701,588

(22) Filed: Feb. 7, 2010

(51) Int. Cl. B60R 1/04

(52) U.S. Cl. 248/479

(57) ABSTRACT

An angle adjustment device for a vehicle rear view mirror is capable of improving the angle-adjustment capability of the movable board while preventing shaking of the movable board with respect to the fixing seat assembly, thus improving safe driving. The angle adjustment device comprises: a fixing seat assembly, a movable board, two arc-shaped racks and two driving units. The movable board and the arc-shaped racks are designed to be movable along the circle path around the center of the pivot connecting portion of the movable board, so that the angle-adjustment capability of the movable board can be improved.

### BACKGROUND OF THE INVENTION

1. Field of the Invention

The present invention relates to a vehicle rear view mirror, and more particularly to an angle adjustment device for a vehicle rear view mirror.

2. Description of the Prior Art

A vehicle is normally provided at both sides thereof with a rear mirror which allows the driver to see behind the vehicle. The rear mirror normally comprises a mirror holder fixed on the vehicle, an angle adjustment device disposed in the mirror holder, and a mirror disposed on the angle adjustment device. The angle adjustment device allows the driver in the vehicle to adjust the angle of the mirror.

Referring to FIG. 1, an angle adjustment device disclosed in Taiwan Pt M297884 is suitable for being disposed between a mirror holder and a mirror and essentially comprises: a fixing seat 11, a movable board 12, two driving mechanisms 13 and a circuit board 14. Each of the driving mechanisms 13 comprises a driving member 131 fixed on the fixing seat 11 and a straight rack 132 connected to the movable board 12 and engaged with the driving member 131. However, such angle adjustment device has the following disadvantages that need to be improved:

Since the movable board 12 is deflection angle adjustable in different directions with respect to the fixing seat 11, while the driving member 131 drives the rack 132 to perform linear adjustment, the rack 132 is unable to drive the movable board 12 to perform a relatively large deflection angle adjustment, and thus the angle adjustment of the mirror is limited.

Furthermore, once the deflection angle of the movable board 12 adjusted by the linearly movable rack 132 is overly large, the joint between the rack 132 and the movable board 12 will get loose, and as a result, the movable board 12 will become shaky with respect to the fixing seat 11, and so will the rear view mirror, making the driver unable to see the traffic behind the vehicle. That's dangerous.

The present invention has arisen to mitigate and/or obviate the afore-described disadvantages.

### SUMMARY OF THE INVENTION

The primary object of the present invention is to provide an angle adjustment device for a vehicle rear view mirror, which is capable of improving the angle-adjustment capability of the movable board with respect to the fixing seat assembly.

Another object of the present invention is to provide an angle adjustment device for a vehicle rear view mirror, which is capable of preventing shaking of the movable board with respect to the fixing seat assembly, thus improving safe driving.

To achieve the above object, an angle adjustment device for a vehicle rear view mirror in accordance with the present invention comprises: a fixing seat assembly, a movable board, two arc-shaped racks and two driving units. The movable board includes a pivot connecting portion pivotally connected the fixing seat assembly, a center of the pivot connecting portion is a center of a circle path, the movable board is rotatably adjustable along the circle path around the center of the pivot connecting portion. The two arc-shaped racks are slidably disposed in the fixing seat assembly, each of the arc-shaped racks has a first end extending out of the fixing seat assembly and pivotally coupled to the movable board, and the arc-shaped racks are slidable along the circle path around the center of the pivot connecting portion. The two driving units are disposed in the fixing seat assembly and engaged with the arc-shaped racks to drive the arc-shaped racks to slide.

### BRIEF DESCRIPTION OF THE DRAWINGS

FIG. 1 is an illustrative view of an angle adjustment device for a vehicle rear view mirror disclosed in Taiwan Pt M297884;

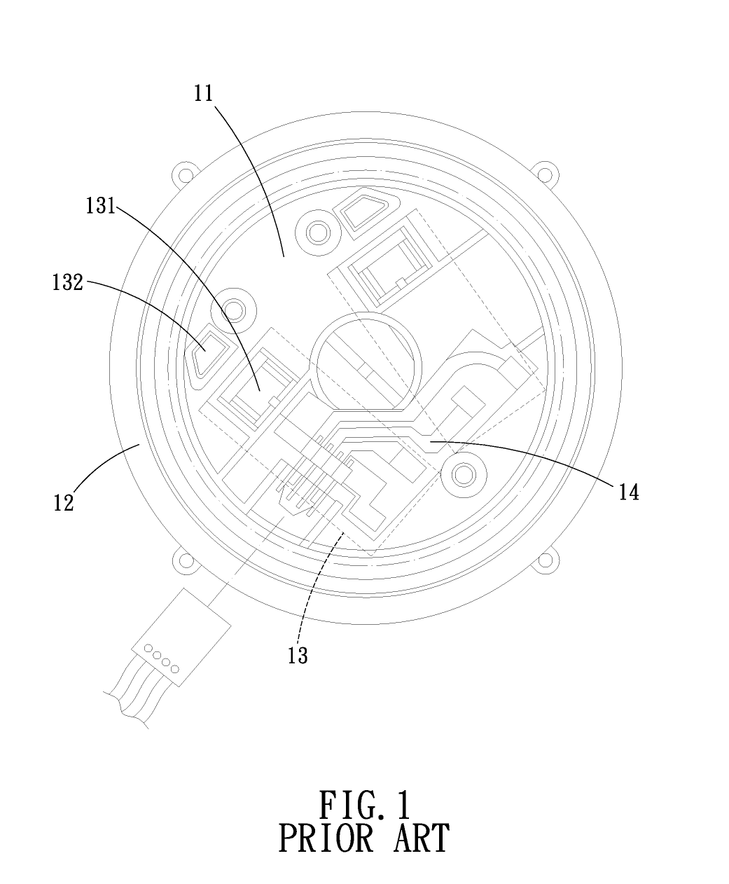

FIG. 2 is an exploded view of an angle adjustment device for a vehicle rear view mirror in accordance with the present invention;

FIG. 3 is a cross sectional view of the angle adjustment device for a vehicle rear view mirror in accordance with the present invention;

FIG. 4 is a top view of the angle adjustment device for a vehicle rear view mirror in accordance with the present invention;

FIG. 5 is a cross sectional view taken along the line 5-5 of FIG. 4;

FIG. 6 is a cross sectional view in accordance with the present invention showing the fixing seat assembly, the movable board, and the arc-shaped racks; and

FIG. 7 is an assembly view in accordance with the present invention showing the fixing seat assembly, the movable board, and the arc-shaped racks.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

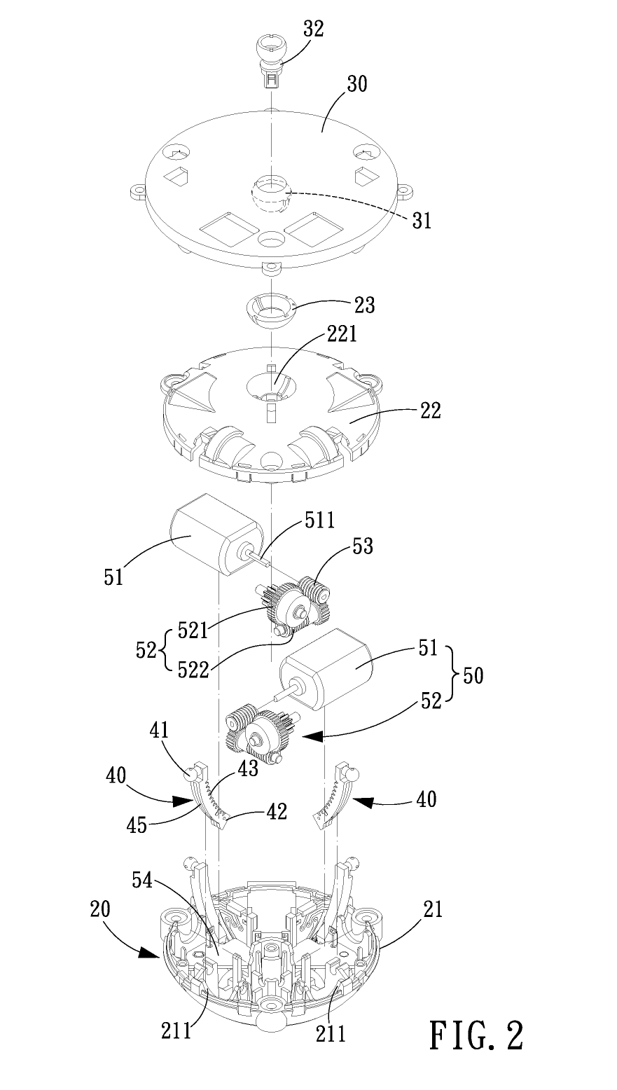

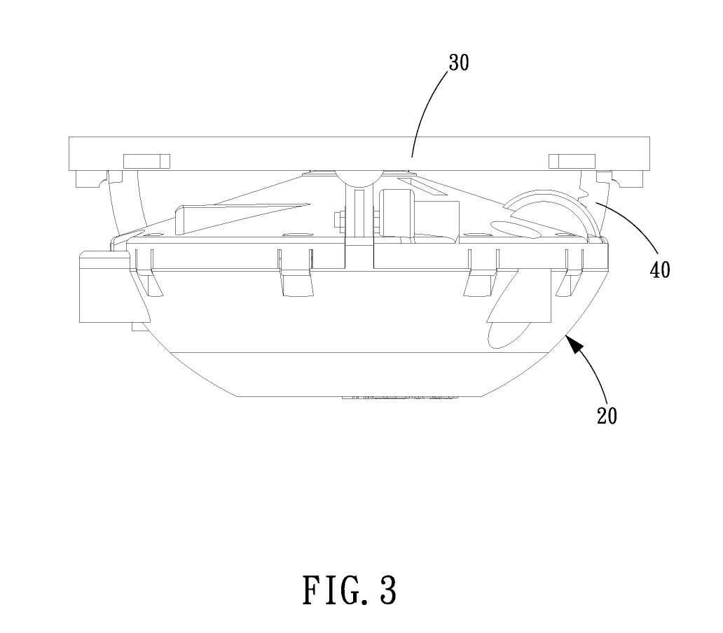

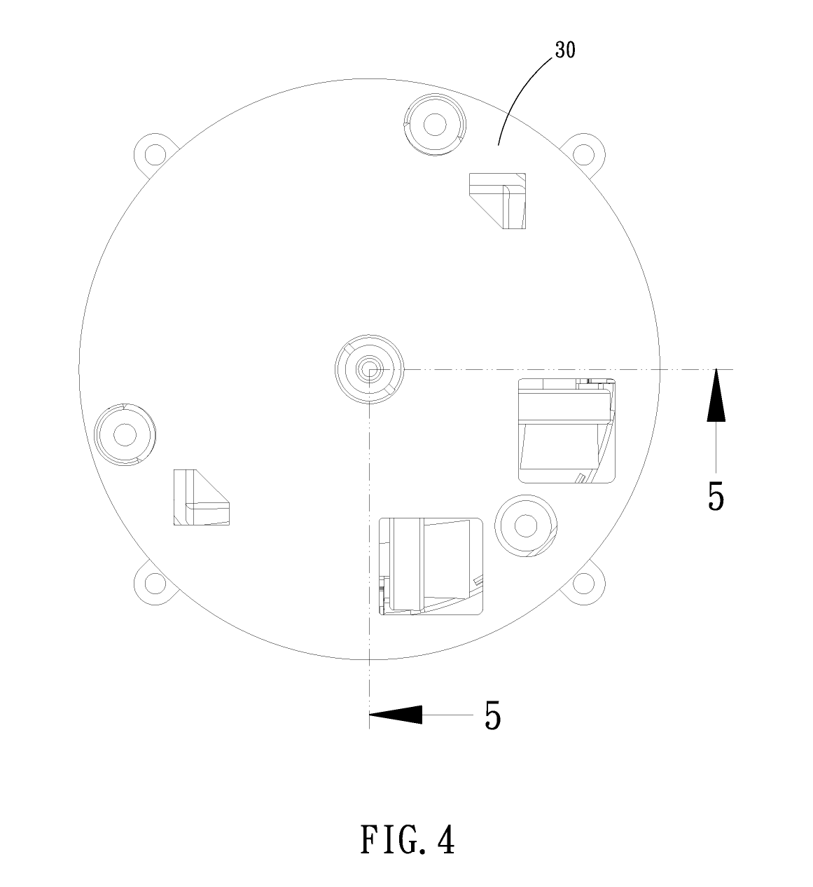

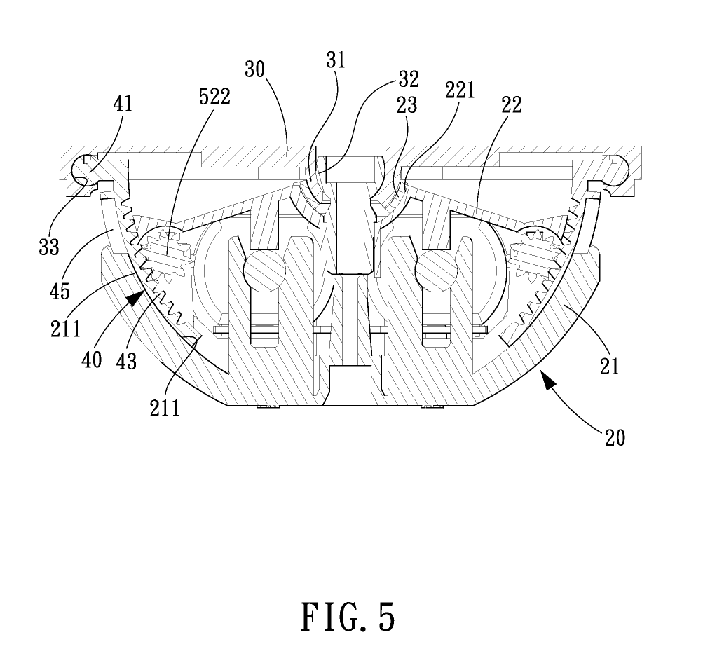

Referring to FIGS. 2-7, an angle adjustment device for a vehicle rear view mirror in accordance with the present invention is disposed between a mirror holder and a mirror and comprises: a fixing seat assembly 20, a movable board 30, two arc-shaped racks 40 and two driving units 50.

The fixing seat assembly 20 includes a seat 21 and a cover 22. The seat 21 is provided on its inner surface with two arc-shaped guiding portions 211 in the form of ribs. Each of the arc-shaped guiding portions 211 includes an arc-shaped center 211A. The cover 22 is covered on the upper end of the seat 21, and the cover 22 is centrally formed with a cavity 221 in which is disposed a restricting member 23.

The movable board 30 includes a pivot connecting portion 31 which is pivotally connected in the cavity 221 of the cover 22 by a fixing member 32 inserted through the pivot connecting portion 31, the restricting member 23, the cavity 221 and positioned on the seat 21. Furthermore, a center 311 of the pivot connecting portion 31 is a center A1 of a circle path A. The movable board 30 is adjustable along the circle path A around the center 311 of the pivot connecting portion 31. The center 311 of the pivot connecting portion 31 and the center 211A of the arc-shaped guiding portions 211 are located at the same point (concentric). The pivot connecting portion 31 is further formed with two spherical cavities 33.

Each of the two arc-shaped racks 40 includes a first end 41 and a second end 42, and between the first and second ends 41, 42 are an inner arc-shaped surface and an outer arc-shaped surface which are located in opposite directions. The inner arc-shaped surface is formed with a toothed portion 43 while the outer arc-shaped surface is formed with an arc-shaped groove 45. The arc-shaped racks 40 are slidably mounted on the arc-shaped guiding portions 211 of the fixing seat assembly 20, respectively, through their arc-shaped groove 45. The first end 41 of each arc-shaped racks 40 is spherical-shaped and extends out of the fixing seat assembly 20 and pivotally engaged in the spherical cavities 33 of the movable board 30, and the arc-shaped racks 40 are slidable along the circle path A around the center 311 of the pivot connecting portion 31, namely, the center 44 of the respective arc-shaped racks 40 is concentric with (located at the same point as) the center 311 of the pivot connecting portion 31.

Each of the two driving units 50 includes a motor 51 and a gear reduction assembly 52 consisting of a first gear 521 and a second gear 522. A shaft 511 of the motor 51 is engaged with the first gear 521 of the gear reduction assembly 52 through a gear sleeve 53. The driving units 50 are disposed in the fixing seat assembly 20 in such a manner that the second gears 522 of the gear reduction assemblies 52 are engaged with the toothed portions 43 of the arc-shaped racks 40 to drive the arc-shaped racks 40 to slide. The driving of the driving units 50 is controlled by a circuit board 54 which is mounted on the fixing seat assembly 20 and electrically connected to the driving units 50.

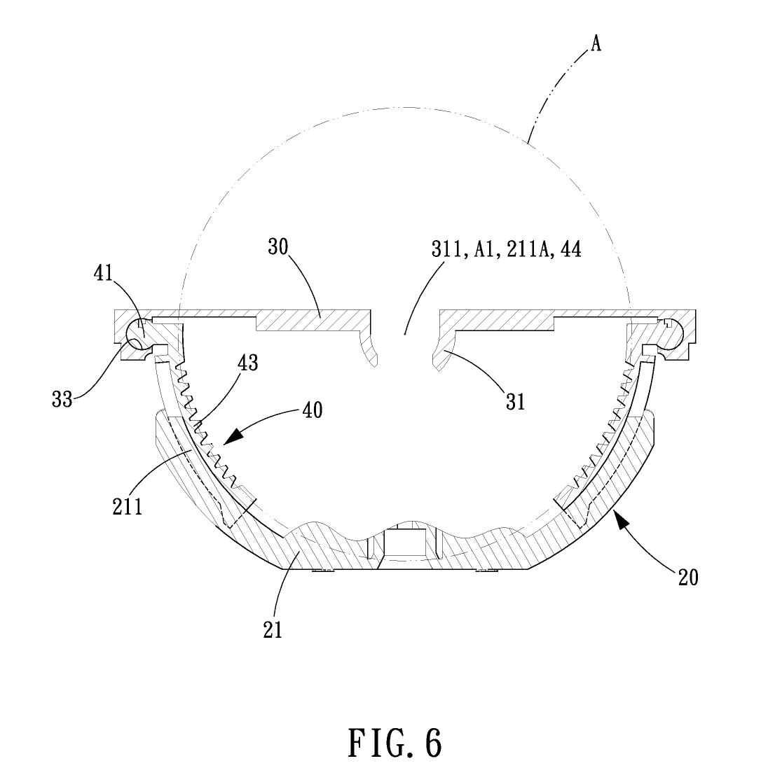

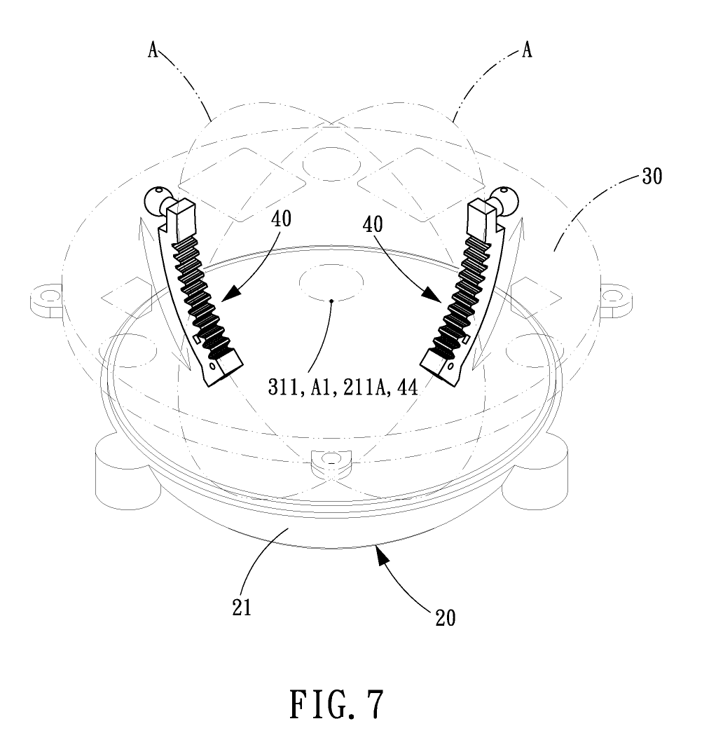

Referring to FIGS. 6 and 7 again, the present invention can at least achieve the following functions and effects:

First, the movable board 30 is pivotally mounted on the fixing seat assembly 20 by the pivot connecting portions 31 and rotatably adjustable along the circle path A around the center 311 of the pivot connecting portion 31, and the respective arc-shaped racks 40 are slidable along the circle path A around the center 311 of the pivot connecting portion 31, that is to say that, the movable board 30 and the arc-shaped racks 40 all move along the circle path A around the center 311 of the pivot connecting portion 31. Therefore, after the arc-shaped racks 40 are driven to move by the driving units 50, the interference cause when the arc-shaped racks 40 drive the movable board 30 to rotate will be reduced due to the fact that the moving path of the arc-shaped racks 40 is the same as the rotation path of the movable board 30, allowing the arc-shaped racks 40 to drive the movable board 30 to perform a relatively large angle adjustment of the movable board 30 with respect to the fixing seat assembly 20. Since the movable board 30 is provided for mounting the rear view mirror, the range of the adjustable angle of the rear view mirror is broadened.

Second, since the movable board 30 and the arc-shaped racks 40 all move along the circle path A around the center 311 of the pivot connecting portion 31, the joint between the movable board 30 and the arc-shaped racks 40 will also move along the circle path A around the center 311 of the pivot connecting portion 31. As a result, when angle adjustment of the movable board 30 with respect to the fixing seat assembly 20 caused by the arc-shaped racks 40 is overly large, the joint between the movable board 30 and the arc-shaped racks 40 is less likely to get loose, thus preventing shaking of the movable board 30 with respect to the fixing seat assembly 20.

It is to be noted that the arc-shaped racks 40 are pivotally connected to the spherical cavities 33 of the movable board 30 through the spherical first ends 41, which contributes to the reduction of interference caused when the arc-shaped racks 40 drive the movable board 30 to rotate, allowing the arc-shaped racks 40 to drive the movable board 30 to perform a relatively large angle adjustment with respect to the fixing seat assembly 20, and preventing the joint between the movable board 30 and the arc-shaped racks 40 from getting loose, thus improving safe driving.

While we have shown and described various embodiments in accordance with the present invention, it is clear to those skilled in the art that further embodiments may be made without departing from the scope of the present invention.

What is claimed is:

1. An angle adjustment device for a vehicle rear view mirror comprising:
a fixing seat assembly;
a movable board including a pivot connecting portion pivotally connected the fixing seat assembly, a center of the pivot connecting portion being a center of a circle path, the movable board being rotatably adjustable along the circle path around the center of the pivot connecting portion;
two arc-shaped racks slidably disposed in the fixing seat assembly, each of the arc-shaped racks having a first end extending out of the fixing seat assembly and pivotally coupled to the movable board, and the arc-shaped racks being slidable along the circle path around the center of the pivot connecting portion; and
two driving units disposed in the fixing seat assembly and engaged with the arc-shaped racks to drive the arc-shaped racks to slide.

2. The angle adjustment device for a vehicle rear view mirror as claimed in claim 1, wherein the fixing seat assembly includes a seat and a cover.

3. The angle adjustment device for a vehicle rear view mirror as claimed in claim 2, wherein the seat is provided on its inner surface with two arc-shaped guiding portions for slidably mounting the two arc-shaped racks, and the center of the pivot connecting portion and a center of the arc-shaped guiding portions are located at the same point.

4. The angle adjustment device for a vehicle rear view mirror as claimed in claim 3, wherein each of the arc-shaped guiding portions is a rib, and each of the arc-shaped racks includes an outer arc-shaped surface which is formed with an arc-shaped groove for slidably engaging with the arc-shaped guiding portions.

5. The angle adjustment device for a vehicle rear view mirror as claimed in claim 3, wherein a center of the respective arc-shaped racks and the center of the pivot connecting portion are located at the same point.

6. The angle adjustment device for a vehicle rear view mirror as claimed in claim 1, wherein the movable board is further formed with two spherical cavities, and one end of each arc-shaped racks is spherical-shaped and pivotally engaged in the spherical cavities of the movable board.

7. The angle adjustment device for a vehicle rear view mirror as claimed in claim 1, wherein each of the two driving units includes a motor and a gear reduction assembly.

8. The angle adjustment device for a vehicle rear view mirror as claimed in claim 7, wherein a shaft of each of the motors is engaged with a first gear of each of the gear reduction assemblies through a gear sleeve, and a second gear of each of the gear reduction assemblies is engaged with each of the arc-shaped racks.

9. The angle adjustment device for a vehicle rear view mirror as claimed in claim 8, wherein each of the two arc-shaped racks includes an inner arc-shaped surface which is formed with a toothed portion for engaging with the second gear of each of the gear reduction assemblies.

10. The angle adjustment device for a vehicle rear view mirror as claimed in claim 1, wherein the cover is centrally formed with a cavity in which is disposed a restricting member, the movable board includes a pivot connecting portion which is pivotally connected in the cavity of the cover by a fixing member inserted through the pivot connecting portion, the restricting member, the cavity and positioned on the seat.
